(19) United States
(12) Patent Application Publication
(10) Pub. No.: US 2025/0071591 A1
(43) Pub. Date: Feb. 27, 2025

(54) ASSIGNING MEASUREMENTS TO GAPS

(71) Applicant: Nokia Technologies Oy, Espoo (FI)

(72) Inventors: Lars DALSGAARD, Oulu (FI); Tero HENTTONEN, Espoo (FI); Rafael CAUDURO DIAS DE PAIVA, Aalborg (DK); Jürgen HOFMANN, Merching (DE)

(21) Appl. No.: 18/810,834

(22) Filed: Aug. 21, 2024

Related U.S. Application Data
(60) Provisional application No. 63/533,714, filed on Aug. 21, 2023.

(51) Int. Cl. H04W 24/10

(52) U.S. Cl. CPC H04W 24/10

(57) ABSTRACT

An apparatus configured to: transmit an indication of at least one measurement capability, wherein the at least one measurement capability comprises, at least, an indication that the apparatus is capable of measuring at least one carrier without at least one measurement gap; receive an indication of at least one measurement configuration, wherein the at least one measurement configuration comprises, at least, an indication to measure the at least one carrier within the at least one measurement gap; and measure the at least one carrier within the at least one measurement gap based, at least partially, on the at least one measurement configuration.

### TECHNICAL FIELD

The example and non-limiting embodiments relate generally to radio resource management (RRM) and, more particularly, to scheduling of user equipment (UE) measurements relative to measurement gaps.

### BACKGROUND

It is known, in cellular communication, to allow a network to use network controlled small gaps (NCSG).

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: transmit an indication of at least one measurement capability, wherein the at least one measurement capability comprises, at least, an indication that the apparatus is capable of measuring at least one carrier without at least one measurement gap; receive an indication of at least one measurement configuration, wherein the at least one measurement configuration comprises, at least, an indication to measure the at least one carrier within the at least one measurement gap; and measure the at least one carrier within the at least one measurement gap based, at least partially, on the at least one measurement configuration.

In accordance with one aspect, a method comprising: transmitting, with a user equipment, an indication of at least one measurement capability, wherein the at least one measurement capability comprises, at least, an indication that the user equipment is capable of measuring at least one carrier without at least one measurement gap; receiving an indication of at least one measurement configuration, wherein the at least one measurement configuration comprises, at least, an indication to measure the at least one carrier within the at least one measurement gap; and measuring the at least one carrier within the at least one measurement gap based, at least partially, on the at least one measurement configuration.

In accordance with one aspect, an apparatus comprising means for: transmitting an indication of at least one measurement capability, wherein the at least one measurement capability comprises, at least, an indication that the apparatus is capable of measuring at least one carrier without at least one measurement gap; receiving an indication of at least one measurement configuration, wherein the at least one measurement configuration comprises, at least, an indication to measure the at least one carrier within the at least one measurement gap; and measuring the at least one carrier within the at least one measurement gap based, at least partially, on the at least one measurement configuration.

In accordance with one aspect, a non-transitory computer-readable medium comprising program instructions stored thereon for performing at least the following: causing transmitting of an indication of at least one measurement capability, wherein the at least one measurement capability comprises, at least, an indication that a user equipment is capable of measuring at least one carrier without at least one measurement gap; causing receiving of an indication of at least one measurement configuration, wherein the at least one measurement configuration comprises, at least, an indication to measure the at least one carrier within the at least one measurement gap; and measuring the at least one carrier within the at least one measurement gap based, at least partially, on the at least one measurement configuration.

In accordance with one aspect, an apparatus comprising: at least one processor; and at least one memory storing instructions that, when executed by the at least one processor, cause the apparatus at least to: receive an indication of at least one measurement capability of a user equipment, wherein the at least one measurement capability comprises, at least, an indication that the user equipment is capable of measuring at least one carrier without at least one measurement gap; determine whether the at least one carrier is to be measured within the at least one measurement gap based, at least partially, on the at least one measurement capability; transmit, to the user equipment, an indication of at least one measurement configuration, wherein the at least one measurement configuration comprises, at least, an indication to measure the at least one carrier within the at least one measurement gap in response to a determination that the at least one carrier is to be measured within the measurement gap; and schedule the at least one measurement gap.

In accordance with one aspect, a method comprising: receiving, with a network node, an indication of at least one measurement capability of a user equipment, wherein the at least one measurement capability comprises, at least, an indication that the user equipment is capable of measuring at least one carrier without at least one measurement gap; determining whether the at least one carrier is to be measured within the at least one measurement gap based, at least partially, on the at least one measurement capability; transmitting, to the user equipment, an indication of at least one measurement configuration, wherein the at least one measurement configuration comprises, at least, an indication to measure the at least one carrier within the at least one measurement gap in response to a determination that the at least one carrier is to be measured within the measurement gap; and scheduling the at least one measurement gap.

In accordance with one aspect, an apparatus comprising means for: receiving an indication of at least one measurement capability of a user equipment, wherein the at least one measurement capability comprises, at least, an indication that the user equipment is capable of measuring at least one carrier without at least one measurement gap; determining whether the at least one carrier is to be measured within the at least one measurement gap based, at least partially, on the at least one measurement capability; transmitting, to the user equipment, an indication of at least one measurement configuration, wherein the at least one measurement configuration comprises, at least, an indication to measure the at least one carrier within the at least one measurement gap in response to a determination that the at least one carrier is to be measured within the measurement gap; and scheduling the at least one measurement gap.

In accordance with one aspect, a non-transitory computer-readable medium comprising program instructions stored thereon for performing at least the following: causing receiving of an indication of at least one measurement capability of a user equipment, wherein the at least one measurement capability comprises, at least, an indication that the user equipment is capable of measuring at least one carrier without at least one measurement gap; determining whether the at least one carrier is to be measured within the at least one measurement gap based, at least partially, on the at least one measurement capability; causing transmitting, to the user equipment, of an indication of at least one measurement configuration, wherein the at least one measurement configuration comprises, at least, an indication to measure the at least one carrier within the at least one measurement gap in response to a determination that the at least one carrier is to be measured within the measurement gap; and scheduling the at least one measurement gap.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4 is a diagram illustrating features as described herein;

FIG. 5 is a diagram illustrating features as described herein;

FIG. 6 is a diagram illustrating features as described herein;

FIG. 7 is a diagram illustrating features as described herein;

FIG. 8 is a diagram illustrating features as described herein;

FIG. 9 is a flowchart illustrating steps as described herein; and

FIG. 10 is a flowchart illustrating steps as described herein.

### DETAILED DESCRIPTION OF EMBODIMENTS

The following abbreviations that may be found in the specification and/or the drawing figures are defined as follows:

3GPP third generation partnership project

5G fifth generation

5GC 5G core network

AMF access and mobility management function

CE control element

CRAN cloud radio access network

CSSF carrier specific scaling factor

CU central unit

DU distributed unit

eNB (or eNodeB) evolved Node B (e.g., an LTE base station)

EN-DC E-UTRA-NR dual connectivity

en-gNB or En-gNB node providing NR user plane and control plane protocol terminations towards the UE, and acting as secondary node in EN-DC

E-UTRA evolved universal terrestrial radio access, i.e., the LTE radio access technology

FR frequency range

gNB (or gNodeB) base station for 5G/NR, i.e., a node providing NR user plane and control plane protocol terminations towards the UE, and connected via the NG interface to the 5GC

IE information element

I/F interface

L1 layer 1

LTE long term evolution

MAC medium access control

MME mobility management entity

MO measurement object

NCSG network controlled small gaps

ng or NG new generation

ng-eNB or NG-eNB new generation eNB

NR new radio

N/W or NW network

O-RAN open radio access network

PDCP packet data convergence protocol

PHY physical layer

RAN radio access network

RF radio frequency

RLC radio link control

RRC radio resource control

RRH remote radio head

RRM radio resource management

RS reference signal

RU radio unit

Rx receiver

SDAP service data adaptation protocol

SGW serving gateway

SMF session management function

SMTC SSB measurement timing configuration

SSB synchronization signal block

Tx transmitter

UE user equipment (e.g., a wireless, typically mobile device)

UPF user plane function

VNR virtualized network function

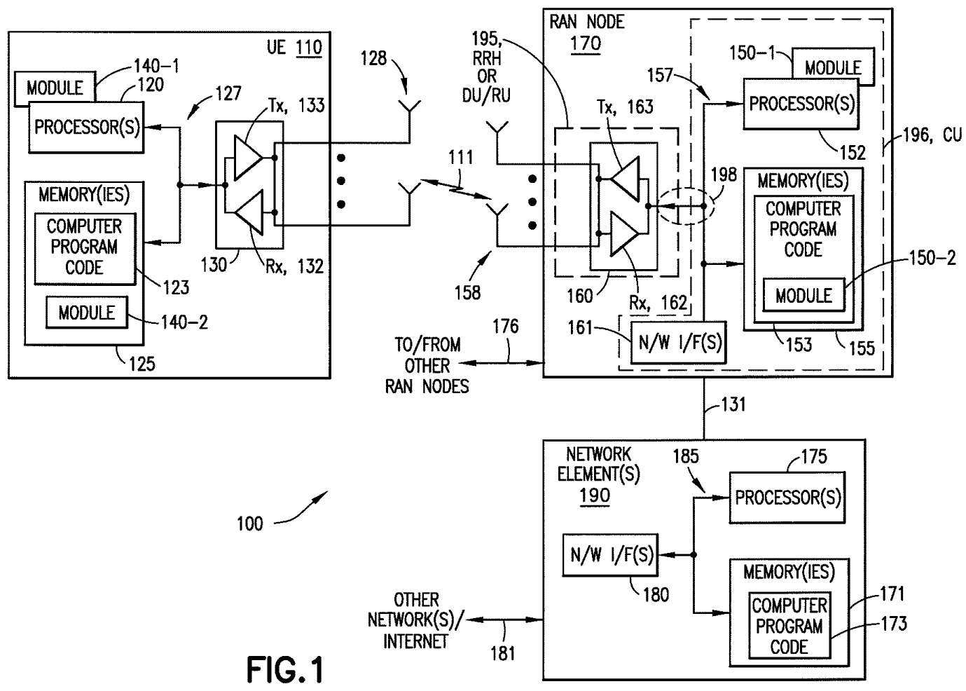

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user planc and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the example embodiments of the present disclosure, example embodiments will now be described with greater specificity.

Features as described herein may generally relate to measurements, such as those done for the purpose of radio resource management (RRM). In a cellular network, RRM measurements are usually utilized to ensure that the UE stays connected to the best cell. The RRM measurements are applied to both the serving cell(s) and neighbour cells, but at a minimum the UE will regularly measure the serving cell and also perform search for neighbor cells on the serving carrier. However, in many cases the UE additionally has to search for and measure cells on other carriers besides the serving cell carrier(s). This is done by the network configuring the UE with which carriers to measure, and when to report the acquired measurement results to the network. The UE will be performing those measurements and reporting according to the network configuration, and the UE shall follow specific UE requirements, which determine requirements related to how often the UE should measure the serving cells on serving carriers and/or neighbour cells in serving or neighbour carriers.

In the present disclosure, the terms “measurement gap” and “gap” may be used interchangeably.

For some carriers configured for measurements (which we will call measured carriers), these measurements may be impossible without the use of measurement gaps, wherein the UE temporarily stops using the current serving carrier(s), tunes its receiver to the carrier to be measured, and only performs the measurements on the measured carrier(s) (hence, UE cannot receive data on some or all of the serving cells/carriers). On some other carriers, the UE may be able to perform the measurements without gaps while continuing using the current serving carrier(s). However, performing such measurements without gaps may cause some interruptions to some or all of the serving carrier(s) in certain cases.

For robust network operation, the network needs to know which carriers the UE can measure without gaps, and for which carriers the UE needs gap to measure (as the network needs to allocate gaps to the UE). Additionally, the network needs to know whether the UE causes interruptions on the serving carrier(s) during the measurements without gaps. These are being discussed in 3GPP RAN working group 4 (RAN4) as of Rel-18 work.

Network controlled small gaps (NCSG) are shorter gaps than the regular measurement gaps and were first defined in LTE Rel-14, and allow the network to specify when the UE is allowed to cause interruptions due to measurements: when the UE is configured with NCSG, it is expected to perform RF retuning due to measurements during the NCSG only, which may allow UE to perform some measurements without gaps. However, this still doesn't allow the network to verify that UE shall use these gaps for measurements (as the requirements specified in TS36.133 do not account for those cases).

In the NR system, two basic types of measurement gaps were defined originally: Per-FR and Per-UE measurement gaps. The per-UE gaps are the same as earlier, wherein the UE only does measurements during the gaps, but the per-FR gaps allow the network to designate certain gaps to certain frequency ranges (FR) if the UE supports such feature(s). This means that the UE only stops receiving serving cells using the respective frequency range during the gaps, for example during the FR1 gap the UE continues using FR2 serving cells and during the FR2 gap the UE continues to use FR1 serving cells. Hence, the network can designate certain inter-FR measurements to specific measurement gaps without affecting the intra-FR measurements. However, intra-FR measurements may still cause interruptions or require per-FR gaps. Additionally, NCSG and concurrent measurement gaps have been defined. The NCSG are the same as in LTE, while the concurrent measurement gaps were defined to allow the UE to have, for example, two concurrent measurement gaps so that each measurement is assigned to only one of the measurement gaps.

Features as described herein may generally relate to RAN4 requirements. RAN4 has defined extensive UE requirements related to measurements, both for UE measurements not using measurement gaps and for UE measurements using measurement gaps. Additionally, UE requirements account for many different scenarios. For example: intra-frequency measurements without gaps; intra-frequency measurements with gaps; inter-frequency measurements with gaps; and inter-frequency measurements without gaps.

RAN4 has also defined requirements for the scenario where the UE is configured with a mix of having gap assisted and non-gap-assisted measurements simultaneously. For this purpose, and due to having limited the measurement occasions to when the synchronization signal block (SSB) measurement timing configuration (SMTC) for the to-be measured carrier is present, RAN4 has defined how/when the UE shall measure certain carriers within gaps and outside gaps depending on the UE capability and measurement gap allocation. The measurements done with measurement gaps also generally require more time as the number of measured carriers increases, since the UE requires more time to receive energy from each carrier to obtain measurement results.

TS38.133 states, with respect to the scenario where the UE is not configured with concurrent measurement gaps, that the UE may or may not support independent measurement gap patterns for different frequency ranges. In the former case, a single per-UE measurement gap pattern may be supplied, while in the latter case, per-FR measurement gap patterns or a single per-UE measurement gap pattern may be supplied. In the former case, in order to enable the UE to perform the measurements, a single per-UE measurement gap pattern may be supplied, while in the latter case, the network must provide a gap pattern.

TS38.133 states, with respect to the scenario where the UE needs gaps to identify and measure cells on intra-frequency carriers, or when the SMTC configured for intra-frequency measurement are fully overlapping with per-UE measurement gaps, measurement gaps can be shared under certain circumstances. The network may signal measurement gap sharing via RRC parameter MeasGapSharingScheme (see, e.g., 9.1.2.1a SA: Measurement Gap Sharing; Table 9.1.2.1a-1: Value of parameter X for NR standalone measurement gap sharing).

This accounts for when all intra-frequency SMTC measurement overlap with measurement gaps. Then, the network can configure how many gap occasions shall be allocated for intra-frequency measurements.

If not all intra-frequency measurement occasions are overlapping with measurement gaps, RAN4 has defined rules regarding which measurements are to be measured within measurement gaps, and which measurements are to be measured outside measurement gaps. Those rules include also a carrier-specific scaling factor (CSSF), which scales the measurement delay requirements when the UE is configured to monitor multiple measurement objects and are described below:
“ . . . 9.1.5 Carrier-specific scaling factor
This clause specifies the derivation of carrier-specific scaling factor (CSSF) values, which scales the measurement delay requirements given in clause 9.2, 9.2A, 9.3, 9.3A, 9.4, and NR PRS-based positioning measurements in clause 9.9 and CSI-RS based L3 measurement in clause 9.10 when UE is configured to monitor multiple measurement objects. The CSSF values are categorized into CSSF_{outside_gap,i} and CSSF_{within_gap,i}, for the measurements conducted outside measurement gaps and within measurement gaps, respectively.
9.1.5.1 Monitoring of multiple layers outside gaps
Otherwise [when UE is not configured with concurrent measurement gaps], the carrier-specific scaling factor CSSFoutside_gap,i for measurement object i derived in this chapter is applied to following measurement types:
   SSB-based intra-frequency measurement with no measurement gap in clause 9.2.5 and 9.2A.5, when none of the SMTC occasions of this intra-frequency measurement object are overlapped by the measurement gap or concurrent measurement gaps.
   SSB-based intra-frequency measurement with no measurement gap in clause 9.2.5 and 9.2A.5, when part of the SMTC occasions of this intra-frequency measurement object are overlapped by the measurement gap or concurrent measurement gaps.
   For a UE in E-UTRA-NR dual connectivity operation, NR SSB-based inter-RAT measurement object configured by the E-UTRAN PCell on an NR serving carrier
      the SSB is completely contained in the active BWP of the UE, and
      none or part of the SMTC occasions of this inter-RAT measurement object are overlapped by the measurement gap or concurrent measurement gaps.
   CSI-RS based intra-frequency measurement in clause 9.10.2, when none of CSI-RS resources for L3 measurement of this intra-frequency measurement object are overlapped by the measurement gap or concurrent measurement gaps.
   CSI-RS based intra-frequency measurement in clause 9.10.2, when all CSI-RS resources for L3 measurement of this intra-frequency measurement object are partially overlapped by the measurement gap or concurrent measurement gaps.
   SSB-based inter-frequency measurement with no measurement gap in clause 9.3.9, when none of the SMTC occasions of this inter-frequency measurement object are overlapped by the measurement gap or concurrent measurement gaps, if UE supports interFrequencyMeas-NoGap-r16 and the flag interFrequencyConfig-NoGap-r16 is configured by the Network.
   SSB-based inter-frequency measurement with no measurement gap in clause 9.3.9, when part of the SMTC occasions of this inter-frequency measurement object are overlapped by the measurement gap or concurrent measurement gaps, if UE supports interFrequencyMeas-NoGap-r16 and the flag interFrequencyConfig-NoGap-r16 is configured by the Network.
   For a UE in E-UTRA-NR dual connectivity operation, NR SSB-based inter-RAT measurement object configured by the E-UTRAN PCell on an NR serving carrier
      the SSB is completely contained in the active BWP of the UE, and
      none or part of the SMTC occasions of this inter-RAT measurement object are overlapped by the measurement gap;
   Intra-frequency RSSI and channel occupancy measurement with no measurement gap on a carrier subject to CCA when SMTC and RMTC are overlapping and RMTCs are not fully overlapped with measurement gap.
UE is expected to conduct the measurement of this measurement object i only outside the measurement gaps.
9.1.5.2 Monitoring of multiple layers within gaps
Otherwise [For a UE supporting concurrent gaps and when concurrent gaps are configured], the carrier-specific scaling factor CSSFwithin_gap,i for a measurement object i derived in this chapter is applied to following measurement types:
   SSB-based intra-frequency measurement object with no measurement gap in clause 9.2.5 and 9.2A.5, when all of the SMTC occasions of this intra-frequency measurement object are overlapped by the measurement gap or concurrent measurement gaps.
   SSB-based intra-frequency measurement object with measurement gap in clause 9.2.6 and 9.2A.6.
   CSI-RS based inter-frequency measurement in clause 9.10.3, when CSI-RS resources for L3 measurement of this inter-frequency measurement object are overlapped by the measurement gap or concurrent measurement gaps.
   CSI-RS based inter-frequency measurement in clause 9.10.3, when CSI-RS resources for L3 measurement of this inter-frequency measurement object are partially overlapped by the measurement gap or concurrent measurement gaps.
   SSB-based inter-frequency measurement object with measurement gap in clause 9.3.4.
   SSB-based inter-frequency measurement object without measurement gap for UE capable of interFrequencyMeas-NoGap in clause 9.3.9, when
      all of the SMTC occasions of this inter-frequency measurement object are overlapped by the measurement gap or concurrent measurement gaps, or
      part of the SMTC occasions of this inter-frequency measurement object are overlapped by the measurement gap or concurrent measurement gaps, but the flag interFrequencyConfig-NoGap-r16 is not configured by the Network.
   Intra-frequency RSSI/CO measurement with measurement gap in clause 9.2A.7.
   Intra-frequency RSSI/CO measurement with no measurement gap in clause 9.2A.7 when all of the RMTC occasions of this intra-frequency RSSI/CO measurement are overlapped by the measurement gap(s).
   Inter-frequency RSSI/CO measurement in clause 9.3A.8 and 9.3A.9.
   E-UTRA Inter-RAT measurement object in clauses 9.4.2 and 9.4.3.
   NR PRS-based measurements for positioning in clause 9.9.
   E-UTRA Inter-RAT RSTD and E-CID measurements in clauses 9.4.4 and 9.4.5.
   For a UE in E-UTRA-NR dual connectivity operation, NR SSB-based Inter-RAT measurement object configured by the E-UTRAN PCell (TS 36.133 clause 8.17.4) on an NR serving carrier
      the SSB is not completely contained in the active BWP of the UE, or
      all of the SMTC occasions of this inter-RAT measurement object are overlapped by the measurement gap;
   NR SSB-based Inter-RAT measurement object configured by the E-UTRAN PCell (TS 36.133 clause 8.17.4) on an NR non-serving carrier.
   E-UTRAN Inter-frequency measurement object configured by the E-UTRAN PCell (TS 36.133 clause 8.17.3) and by the E-UTRAN PSCell (TS 36.133 clause 8.19.3).
   E-UTRAN Inter-frequency RSTD measurement configured by the E-UTRAN PCell (TS 36.133 clause 8.17.15).
   UTRA Inter-RAT measurement object configured by the E-UTRAN PCell (TS 36.133 clauses 8.17.5 to 8.17.12).
   GSM Inter-RAT measurements configured by the E-UTRAN PCell (TS 36.133 clauses 8.17.13 and 8.17.14).
The UE is expected to conduct the measurement of this measurement object i only within the measurement gaps. If UE is configured with concurrent measurement gaps and an association between measurement object i and certain measurement gaps is provided, the requirements are defined assuming the UE shall conduct the measurement of this measurement object i at least within the associated measurement gaps . . . ”

These rules are currently defined, and state which measurements are to be performed within gaps, and which are allowed to be performed outside gaps. Whether the UE needs gaps for performing measurements on a certain carrier is a UE capability and indicated to the network. The network has no influence on the UE capabilities that the UE indicates, so the network may not be able to control whether the UE performs measurements within measurement gaps, or outside measurement gaps (whether with or without interruption). These capabilities are generally indicated only once and stored in the network, and they do not change frequently, which may cause the UEs to indicate conservative measurement gap capabilities since the gap usage is not tied to a specific configuration. For that reason, the feature NeedForGaps was defined to allow the network to additionally request UE measurement gap capabilities based on the current network configuration and desired frequencies to measure: the network requests for the UE to indicate whether to requires gaps for measurements on a given set of carriers with the current configuration, and the UE indicates this in the response to the network. This allows more dynamic usage of the measurement gaps, as the UE can be more responsive to the current configuration.

Features as described herein may generally relate to the Rel 18 need for interruptions. In Rel 18, a new feature is being developed by RAN4 where a UE supporting gapless measurements may also cause interruption when performing such measurements. In order to do so, the needForGaps framework is extended.

In the new signaling design developed by RAN2 (e.g. R2-2306804), a new signalling element (which we will also abbreviate as “IE” in the context of this discussion) is included for the network to configure the NeedForGap information related to the interruptions, called NeedForInterruptionConfigNR-r18, to which the UE replies with the information on whether the measurements not requiring gaps also cause interruptions, using the signalling information defined in a signalling element called NeedForInterruptionInfoNR-r18. The RAN2 design includes a single flag for requesting the UE whether interruption is needed by the UE when performing the gapless measurements, which is complemented/associated with a UE response including the corresponding entry in list interFreq-needForGap-r16.

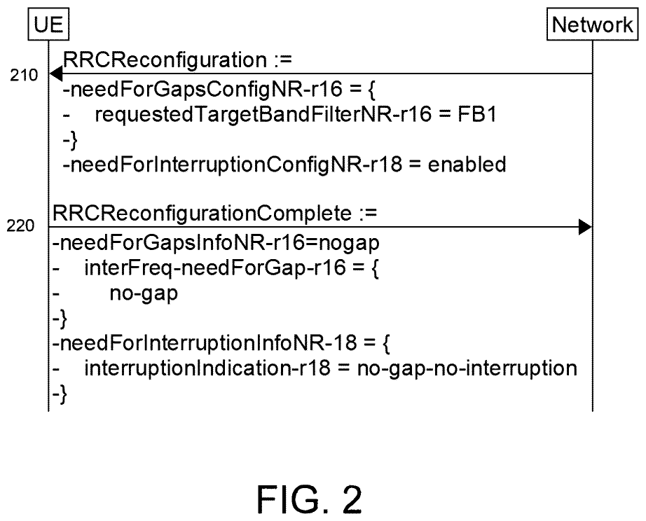

Referring now to FIG. 2, illustrated is an example of signaling introduced by RAN2 for indication of a need for interruption. At 210, the network may transmit, to a UE, an RRCReconfiguration message including needForInterruptionConfigNR-r18, which may be enabled. At 220, the UE may transmit, to the network, interFreq-needForGap-r16, which may include an indication of no-gap; and needForInterruptionInfoNR-18, which may include interruptionIndication-r18 with value no-gap-no-interruption.

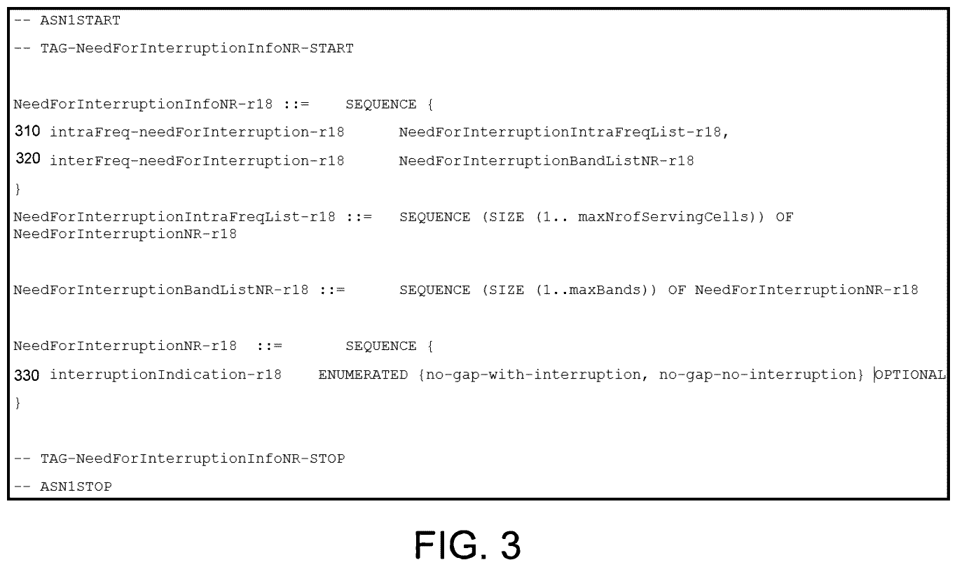

The IE NeedForInterruptionInfoNR indicates whether interruption is needed for the UE to perform SSB-based measurements on an NR target band without measurement gap. Referring now to FIG. 3, illustrated is an example of the NeedForInterruptionInfoNR IE from 38.331. The intraFreq-needForInterruption field (310) indicates the UE's interruption capability information for NR intra-frequency measurement. Each entry in the list is associated to the entry in list intraFreq-needForGap-r16 with the same index. The interFreq-needForInterruption field (320) indicates the UE's interruption capability information for NR inter-frequency measurement. Each entry in the list is associated to the entry in list interFreq-needForGap-r16 with the same index. The interruptionIndication field (330) indicates whether interruption is needed for the UE to perform SSB based measurements without measurement gap. Value no-gap-with-interruption indicates that interruption is needed. Value no-gap-no-interruption indicates interruption is not needed.

With the information of the NeedForInterruptionInfoNR IE, the network can be aware of which frequency layers require interruption in order to perform measurements without gaps.

Features as described herein may generally relate to RAN4 mapping of gaps to measurements. Once the NeedForGaps information is shared by the UE, the network will make an educated guess on which frequency layers are performing measurements with and without gaps. The RRM specification in RAN4 includes the following information about which measurements are performed with and without gaps for intra frequency and inter frequency layers:
“ . . . 9.2 NR intra-frequency measurements
9.2.1 Introduction
A measurement is defined as a SSB based intra-frequency measurement provided the centre frequency of the SSB of the serving cell indicated for measurement and the centre frequency of the SSB of the neighbour cell are the same, and the subcarrier spacing of the two SSBs are also the same.
The UE shall be able to identify new intra-frequency cells and perform SS-RSRP, SS-RSRQ, and SS-SINR measurements of identified intra-frequency cells if carrier frequency information is provided by PCell or the PSCell, even if no explicit neighbour list with physical layer cell identities is provided.
The UE can perform intra-frequency SSB based measurements without measurement gaps (either legacy measurement gap or NCSG) if
   the UE indicates ‘no-gap’ via intraFreq-needForGap for intra-frequency measurement, or
   the SSB is completely contained in the active BWP of the UE, or
   the active downlink BWP is initial BWP [3].
For UE supporting nr-NeedForGapNCSG-reporting-r17 and indicating NeedForGapNCSG-InfoNR for intra-frequency measurement,
   An intra-frequency SSB measurement is defined as measurement without gap if
      the UE indicates ‘nogap-noncsg’ via NeedForGapNCSG-InfoNR for the intra-frequency measurement, and
      the SSB is not completely contained in the active BWP of the UE, and
      the active downlink BWP is not an initial BWP [3]
   The delay requirements are specified in clause 9.2.5
   An intra-frequency SSB measurement is defined as measurement with NCSG if
      the UE indicates ‘ncsg’ via NeedForGapNCSG-InfoNR for the intra-frequency measurement, and
      the SSB is not completely contained in the active BWP of the UE, and
      the active downlink BWP is not an initial BWP [3]
   When network configures NCSG, the delay requirements are specified in clause 9.2.7
   When network configures measurement gap, the delay requirements are specified in clause 9.2.6
   An intra-frequency SSB measurement is defined as measurement with gap if
      the UE indicates ‘gap’ via NeedForGapNCSG-InfoNR for the intra-frequency measurement, and
      the SSB is not completely contained in the active BWP of the UE, and
      the active downlink BWP is not an initial BWP [3]
   When network configures measurement gap, the delay requirements are specified in clause 9.2.6
   The UE can perform intra-frequency SSB based measurement corresponding to a deactivated SCell or dormant SCell with NCSG.
   For intra-frequency SSB based measurements with NCSG, UE may cause scheduling restriction as specified in clause 9.2.7.3.
9.3 NR inter-frequency measurements
9.3.1 Introduction
A measurement is defined as an SSB based inter-frequency measurement provided it is not defined as an intra-frequency measurement according to clause 9.2.
The UE shall be able to identify new inter-frequency cells and perform SS-RSRP, SS-RSRQ, and SS-SINR measurements of identified inter-frequency cells if carrier frequency information is provided by PCell or PSCell, even if no explicit neighbour list with physical layer cell identities is provided.
A measurement is defined as an inter-frequency SSB based measurements without measurement gaps (either legacy measurement gap or NCSG) in active BWP and its delay requirements are specified in clause 9.3.9, for UE capable of interFrequencyMeas-NoGap provided that
   the UE supports inter FrequencyMeas-Nogap-r16 [15], and
   the SSB is completely contained in the active BWP of the UE.
For UE supporting nr-NeedForGapNCSG-reporting-r17 and indicating NeedForGapNCSG-InfoNR for inter-frequency measurement,
   An inter-frequency SSB measurement is defined as measurement without gap if
      the UE indicates ‘nogap-noncsg’ via NeedForGapNCSG-InfoNR for the inter-frequency measurement, and
      the SSB is not completely contained in the active BWP of the UE
   The delay requirements are specified in clause 9.3.9.
   An inter-frequency SSB measurement is defined as measurement with NCSG if
      the UE indicates ‘ncsg’ via NeedForGapNCSG-InfoNR for the inter-frequency measurement, and
      the SSB is not completely contained in the active BWP of the UE
   When network configures NCSG, the delay requirements are specified in clause 9.3.10.
   When network configures measurement gap, the delay requirements are specified in clauses 9.3.4 and 9.3.5.
   An inter-frequency SSB measurement is defined as measurement with gap if
      the UE indicates ‘gap’ via NeedForGapNCSG-InfoNR for the inter-frequency measurement, and
      the SSB is not completely contained in the active BWP of the UE
   When network configures measurement gap, the delay requirements are specified in clauses 9.3.4 and 9.3.5.
   For inter-frequency SSB based measurements with NCSG, UE may cause scheduling restriction as specified in clause 9.3.10.3 . . . ”

Finally, as part of the RAN4 discussion, there was a concern in keeping the number of interruptions reduced for the gapless measurements in Rel 18. For this reason, it was agreed that measurements with interruptions would use a lower bound of 80 ms for measurement cycle. That means that, even if the network configures the SMTC to 20 ms, the UE may perform measurements at most every 80 ms, which will imply longer measurement delays.

The problem for the network is that, if the UE can perform measurements on one or more carrier without gaps but causes interruptions on the serving carrier(s), it may not be possible to know when the UE causes those interruptions.

Additionally, it will also be a challenge controlling the amount of interruptions, and hence facilitating any mitigation or impact, as currently the UE is the entity which indicates whether it can perform the measurements with or without gaps and RAN4 has defined rules about when the UE shall measure certain carriers, depending on whether they can be measured with gaps or not. Based on this, the UE will measure accordingly (see above, CSSF).

In NR Rel-17, the so-called “network-configured small gaps” or NCSG were defined, wherein the network explicitly tells the UE where it may cause interruptions. The duration of these ‘small gaps’ are smaller than legacy gaps, and allows the network to schedule the UE in between the ‘small gaps’, so that they are more efficient.

However, in Rel-18 work, the focus has been on UEs not wanting to use even those NCSG, but instead allowing the UE to cause interruptions, due to measurements without gaps, more freely; hence the UE performs measurements whenever desired while causing (random) interruptions to the reception on the serving carrier(s).

The intent is to allow more UEs to avoid the gaps (which typically degrade throughput performance), but still allow practical implementations of RF retuning and/or RF turning on and off (which may cause interruptions to reception).

This causes a problem for the network, since it may waste scheduling occasions that end up not being used by the UE. Additionally, having an unpredictable and increased number of interruptions will likely have a negative impact on the network scheduler, which may see the dropped packages due to interruptions as link problems and try to actively mitigate the ‘link problem’.

In more detail, after the UE sends the information of NeedForGaps, and NeedForInterruption, it is possible for the network to map, for each measurement object (MO), whether it should be performed within gaps or outside gaps. However, it is currently not possible for the network to mandate that certain measurements are to be performed within gaps.

A measurement object may be considered the specific frequency (range) where an SSB may be found.

Performing measurements within gaps sometimes has advantages, since they provide shorter and predictable measurement delays, and no interruptions are expected for those. In some situations, the measurements without gaps can provide limited benefits, since they also have scheduling restrictions, and might cause interruptions that are unknown by the network.

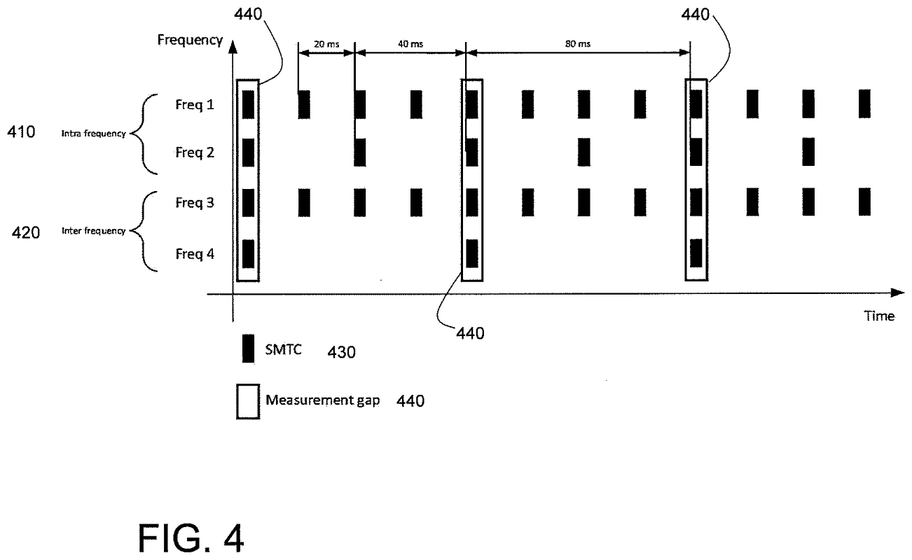

Referring now to FIG. 4, illustrated is a configuration example where four frequency layers and one measurement gap are configured by the network. In this example, there are two intra-frequency layers (410), and two inter-frequency layers (420), and a measurement gap configured with 80 ms periodicity (440). If, in the example of FIG. 4, we consider that the UE reported that it supports no-gap for all frequency layers, there are still the following use case examples where the network may need/want to have control over which frequency layers should be performed within gaps.

Use case 1: minimization of interruptions. Depending on the combination of frequency layers that require interruptions, the network might prioritize certain layers to be performed within gaps in order to reduce the interruptions caused by measurements.

Use case 2: minimization of measurement delay for high priority layers. The network may need to assign a higher priority for some frequency layers. In one example, Freq 3 might be the most likely target for handover, or might be configured for conditional handover. In this case, the network may like to minimize handover delay for this layer.

Therefore, it may be desirable to the network to have more control over the UE while still allowing efficient RRM measurements. This may help the network in mitigating any negative impact caused by UE interruptions.

In an example embodiment, the network may indicate that the UE shall use gaps or a specific gap for performing the measurements of a given carrier, regardless of whether the UE actually requires gaps for performing measurements on the carrier.

In one signaling example, the network may send a new message after receiving needForGapsInfo and, optionally, needForInterruptionInfo. In another signaling example, the network may send a new message after receiving needForGapsInfo. This may have the technical effect of allowing the network to bypass any interruptions the UE may require when doing measurements without gaps. This may also have the technical effect of enabling the network to keep control of which carriers are measured in the SMTC occasions outside the gaps. Hence, those measurements occasions may be used in a more controlled manner, and may be targeted for certain carriers, for example an intra-frequency carrier. This may have the technical effect of enabling the network to ensure that those measurements can be performed faster.

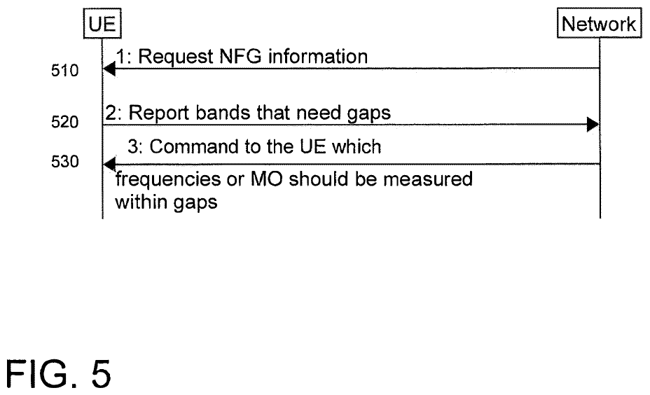

Referring now to FIG. 5, illustrated is an example of the network sending a command to the UE. At 510, the network may transmit, to the UE, a request for NFG information (i.e. needForGapsInfo). At 520, the UE may transmit, to the network, a report of bands that need gaps. At 530, the network may transmit, to the UE, a command as to which frequencies or measurement objects (MO) should be measured within gaps.

In legacy operation, the UE is allowed to do measurements without gaps outside the gaps, and the UE only uses the gaps for the 1) measurements where SMTC overlaps with the gap and 2) measurement(s) which require gap(s).

In an example embodiment, an indication may be specified that indicates that measurement(s) shall be performed within gap(s). In an example embodiment, the indication may indicate that the UE shall not perform the measurement(s) outside the gaps even if the UE has indicated it is capable of performing such measurement without gaps. In other words, the indication may serve to prevent the UE from performing one or more measurements outside of measurement gaps, and/or ensure that one or measurements are performed within a measurement gap.

Hence, even if the UE has indicated to the network that the UE is capable of performing certain measurements of a certain carrier without gaps (but for example with interruptions), the network may indicate to the UE that these same measurements shall be performed within gaps. If the UE has been indicated from the network to perform certain measurements (on a given carrier or carriers) with/using measurements gap(s), the UE follows such a network indication, even if the UE has indicated that the measurement may be performed without gaps (but potentially with interruptions).

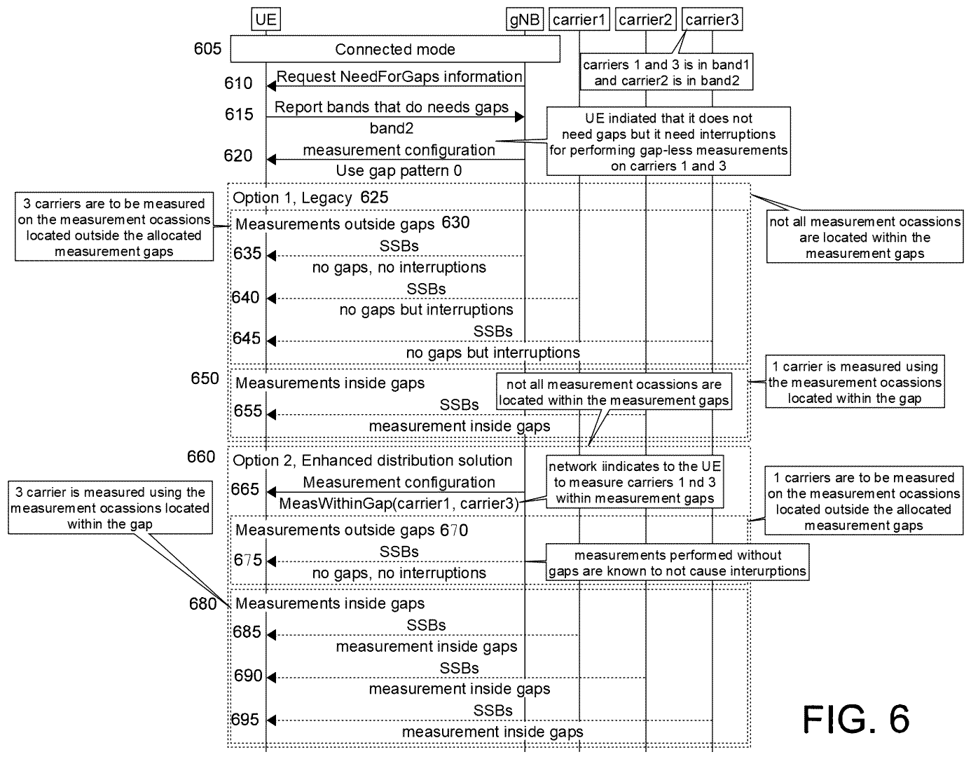

Referring now to FIG. 6, illustrated is an example of measurement configuration according to legacy operation and example embodiments of the present disclosure. In this example, the gNB also represents the serving carrier and cell (hence where UE performs intra-frequency measurements). It is assumed in the example that the UE can perform the intra-frequency measurements without measurement gaps (and without interruptions). It is assumed in the example that the UE need measurement gaps to perform measurements on carrier 2. It is assumed in the example that the UE can perform measurements on carriers 1 and 3 without gaps, but while causing interruptions on other serving carriers (in this example, the gNB). It is assumed in the example that the UE is configured with a measurement gap pattern by the network (for example gap pattern #0, 6 ms measurement gap repeated every 40 ms).

In the example, carriers 1 and 3 are in band 1, while carrier 2 is in band 2. At 605, the UE is in a connected mode with the gNB. At 610, the network requests the UE to inform the network about the need for gaps. At 615, the UE reports its need for gaps. Hence, the UE indicates to the network that the UE need gaps to perform measurements on band 2. At 620, the network configures the UE with a measurement configuration requesting the UE to perform measurements on carriers 1, 2 and 3. Additionally, the network allocates the UE with a measurement gap pattern (for example #0).

At 625, option 1, legacy operation, is illustrated. At 630, the UE may initiate measurements on the configured carriers (carriers 1 and 2 and 3). These measurements may be performed on measurement occasions located outside the allocated measurement gap(s). At 635, for UE measurements performed on the serving cell carrier (gNB), the UE may perform the measurements without interruptions. At 640 and 645, for measurements performed by the UE on carriers 1 and 3, the UE may perform the measurement also without measurement gaps, but for each measurement performed the UE may cause interruptions on the serving carrier. Exactly when the UE performs measurements not causing interruptions, and/or performing measurements causing interruptions, is not known to the network, and so the network has to assume that there might be interruptions on all possible measurement occasions which might be used by the UE for measurements outside gaps. At 650, the UE may perform the measurements on measurement occasions within gaps. For example, at 655, the UE may perform the measurement on carrier 2 inside the gap(s).

It may be noted that, in 625 of FIG. 6, the UE may perform measurements on 3 carriers on measurement occasions located outside the measurement gaps and perform measurements on 1 carrier on measurement occasions located within the measurement gaps. As the measurement delay scales with the number of carriers to be measured at each measurement occasion (i.e. more measurement objects require more time), it is clear that the measurement delay for measurements performed on measurement occasions located outside gaps will be longer than for measurement located within measurements gaps (assuming there are 50% measurement occasion distribution within and outside gaps).

At 660, option 2, according to example embodiments of the present disclosure, is illustrated. In this example, it may be that not all measurement occasions are located within measurement gaps (i.e. a UE may intend to perform measurement outside of measurement gaps).

Measurements performed without gaps may cause interruptions. A technical effect of example embodiments of the present disclosure may be to enable the network to mitigate the impact from interruptions.

There may be many carriers to measure on measurement occasions outside measurement gaps. As it is common that the intra-frequency measurements (including measurements on the serving cell) are performed without gaps (hence, outside gaps), having many carriers measured outside gaps may have negative impact on the intra-frequency measurement performance.

Example embodiments of the present disclosure may address some of these concerns.

Referring now to FIG. 6, at 665, the network may explicitly indicate to the UE which carriers are to be measured within measurement gaps (or alternatively, which carriers are to be measured outside gaps, of those carriers for which measurement gaps was indicated to not be needed). In this example, even if the UE has indicated to the network that it can measure carriers 1 and 3 without gaps (but potentially with interruptions), the network may indicate to the UE that it shall measure carriers 1 and 3 within measurement gaps.

In an example embodiment, the measurement configuration at 620 and the measurement configuration at 665 may be combined into a single measurement configuration. Alternatively, they may be separate message transmitted by the network and received by the UE.

At 670, the UE may measure using measurement occasion(s) outside gap(s). Due to the network indication, the UE may now only measure the serving cell/carrier using measurement(s) outside gap(s). These measurements may be performed without causing interruptions. At 675, the UE may measure the serving cell with no gaps and no interruptions. In other words, carriers may be measured on the measurement occasions located outside the allocated measurement gaps.

At 680, the UE may measure using measurement occasions within measurement gaps. Due to the network indication, the UE shall measure carriers 1, 2 and 3 using measurement occasion(s) located within measurement gaps. Note that also carriers 1 and 3 are measured using gaps, in contrast to 625. However, carriers 1 and 3 are not causing any interruptions, as the measurements are performed using gaps.

At 685, the UE measures carrier 1 inside measurement gaps. At 690, the UE measures carrier 2 inside measurement gaps. At 695, the UE measures carrier 3 inside measurement gaps.

A technical effect of example embodiments of the present disclosure may be to enable the network to mitigate and remove interruptions that would otherwise have to be assumed possible at any measurement occasion performed outside gaps. A technical effect of example embodiments of the present disclosure may be to enable the network to reduce the number of carriers measured outside gaps and hence, reduce the measurement delay.

In the example of FIG. 6, the UE indicates what measurements may be performed without gaps but with interruptions. However, this is not limiting; in another example, the UE may also indicate measurements without gaps and no interruptions. Hence, the network may also indicate whether such measurement (without gaps and no interruptions) shall be performed with measurement gaps (despite the UE indication).

In an example embodiment, the measurement configuration (665) may be configured to the UE via RRC and/or indicated to the UE with MAC CE signaling. The RRC configuration may provide a semi-static configuration, and the UE may indicate whether it is capable of such configuration. The MAC CE may then optionally be used to control the usage of the gaps/no-gaps according to network policies, without resorting to RRC configuration.

In an example embodiment, the network may send a new message (e.g. measurement configuration 665) after receiving needForGapsInfo and needForInterruptionInfo (e.g. at 615).

In an example embodiment, the network may use the information provided in needForGapsInfoNR-r16 and needForInterruptionInfoNR-18 and decide which measurements will be performed within gaps or outside gaps. In order to do so, signaling support needs to be provided. At least two approaches may be used to achieve that, by including the information while updating the measurement object configurations (approach 1), or by sending the information for each target band (approach 2).

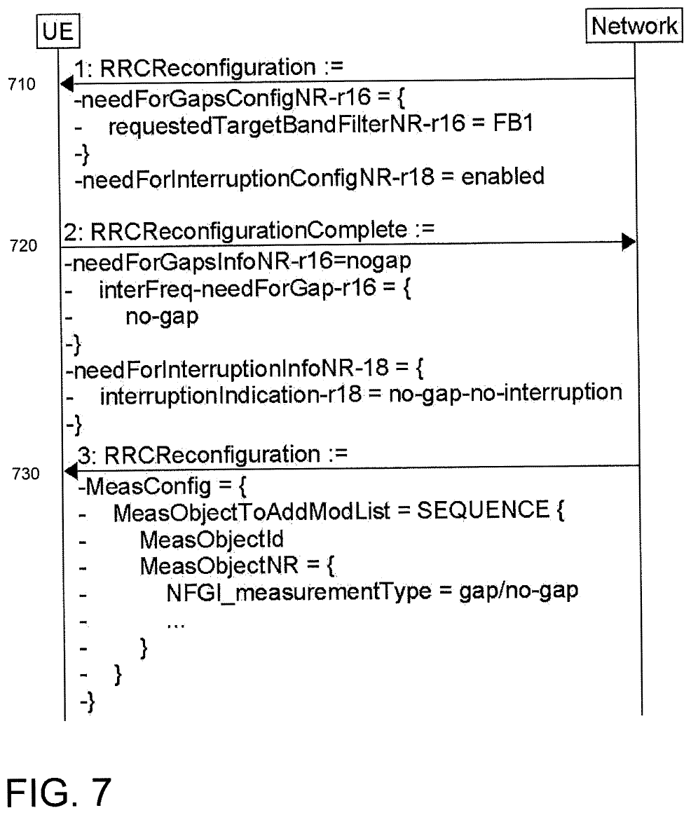

Referring now to FIG. 7, illustrated is an example time diagram for approach 1. In an example embodiment, approach 1 may include explicit configuration of which measurement object (MO) should be measured within gaps after receiving needForGaps and NeedForInterruption report. In this diagram, steps 1 and 2 (710, 720) follow the same flow as currently, with the network configuring the UE to report NeedForGaps and NeedForInterruption in Step 1 (710), and where in Step 2 (710) the UE reports which bands require gaps, and in which bands it can perform measurements without gaps and with/without interruptions. In Step 3 (730), the network sends a new RRCReconfiguration message including measurement configuration, where each measurement object may include a new parameter NFGI_measurementType indicating the measurement type. This parameter may contain the value ‘gap’ in case the network decides that this MO should be measured within gaps, and ‘no-gap’ in case the measurement can be measured without gaps.

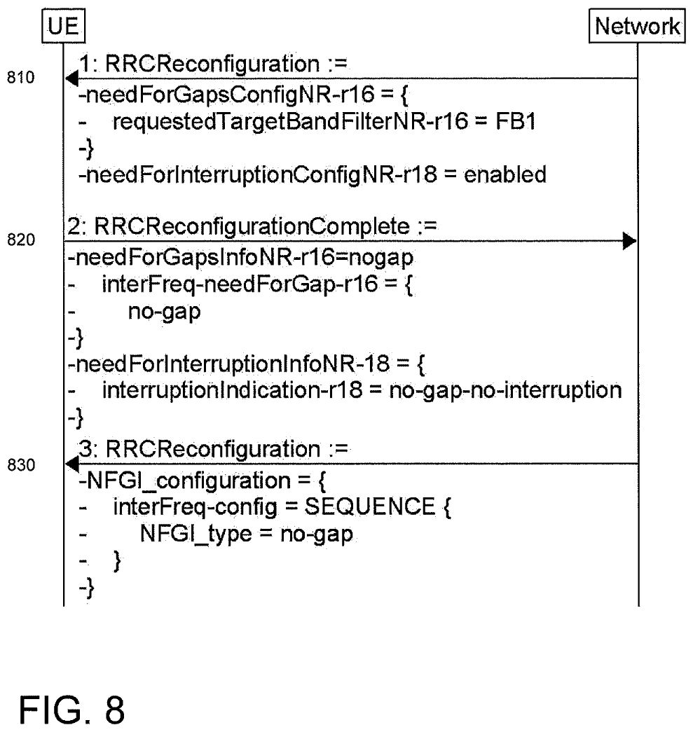

Referring now to FIG. 8, illustrated is an example time diagram for approach 2. In an example embodiment, approach 2 may include explicit configuration of measurement type for each frequency band after receiving needForGaps and NeedForInterruption report. In this diagram, steps 1 and 2 (810, 820) follow the same flow as currently, with the network configuring the UE to report NeedForGaps and NeedForInterruption in Step 1 (810), and where in Step 2 (820) the UE reports which bands require gaps, and in which bands it can perform measurements without gaps and with/without interruptions. In Step 3 (830) a new IE may be included in RRCReconfiguration or a new message type may be used for configuring which frequency bands should have the measurements performed within or outside gaps. This may include, for each band configured in needForGapsConfigNR, an indication of what is the measurement type. In this example, the NFGI_configuration may contain a field for infra frequency, i.e. intraFreq-config, and another for inter frequency bands, i.e. interFreq-config. For each of the intra and inter-frequency bands, the NFGI_type may be included. The value of NFGI_type may be configured by the network as ‘gap’ or ‘no-gap’.

Approach 1 may be performed as in the following example. The network may configure the UE to measure FB1, FB2, FB3, FB4. As illustrated in TABLE 1, the UE may transmit, to the NW, a report containing the following values in needForGapsInfo and NeedForInterruptionInfo:

TABLE 1

| Frequency band | NeedForGapInfo | NeedForInterruptionInfo |
|---|---|---|
| FB1 | gap | — |
| FB2 | no-gap | no-gap-with- |
| | | interruption |
| FB3 | no-gap | no-gap-with- |
| | | interruption |
| FB4 | no-gap | no-gap-no-interruption |

The network may configure gaps and assign which bands should be measured within or outside gaps. In this step, the network may know that at least a gap for measuring FB1 is needed. In this example, the network may decide that FB1 and FB2 can be measured using the same measurement gap in order to minimize the interruption ratio that would be caused by FR2. At the same time, the network may accept FB3 and FB4 to be measured outside of gaps, since only FB3 is causing interruptions resulting in a small overall interruption ratio.

If the network is operating according to approach 1, the network may sends a new RRCReconfiguration including:
measurement gap configuration for FB1 and FB2,
   For the MO's related to FB1 and FB2
      NFGI_measurementType =gap
   For the MO's related to FB3 and FB4
      NFGI_measurementType =no-gap

If the network is operating according to approach 2, the network may send a new RRCReconfiguration including NFGI_configuration according to TABLE 2:

TABLE 2

| Frequency band | NFGI_type |
|---|---|
| FB1 | gap |
| FB2 | gap |
| FB3 | no-gap |
| FB3 | no-gap |

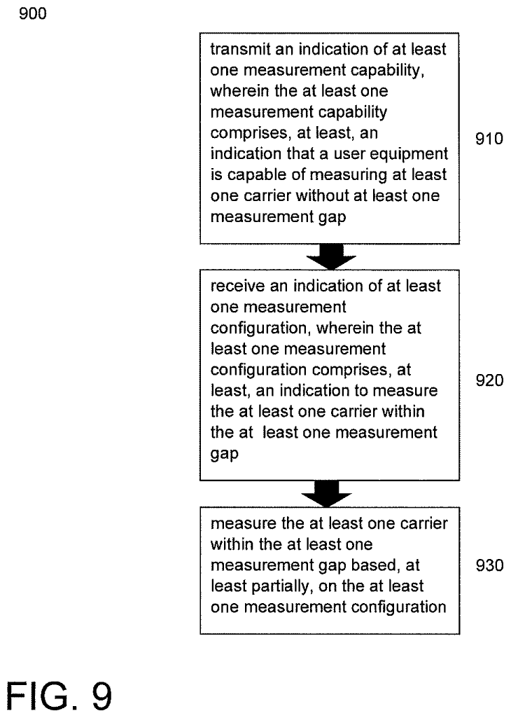

FIG. 9 illustrates the potential steps of an example method 900. The example method 900 may include: transmitting an indication of at least one measurement capability, wherein the at least one measurement capability comprises, at least, an indication that a user equipment is capable of measuring at least one carrier without at least one measurement gap, 910; receiving an indication of at least one measurement configuration, wherein the at least one measurement configuration comprises, at least, an indication to measure the at least one carrier within the at least one measurement gap, 920; and measuring the at least one carrier within the at least one measurement gap based, at least partially, on the at least one measurement configuration, 930. The example method 900 may be performed, for example, with a UE. In an example embodiment, the indication of the at least one measurement capability may include an indication of a carrier that may be measured without a measurement gap that is not indicated to be measured in a measurement gap via the at least one measurement configuration, and therefore may be measured without a measurement gap.

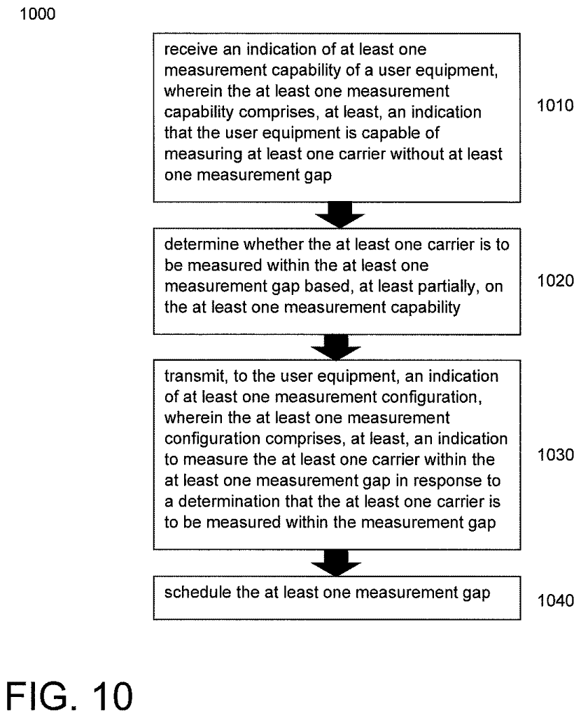

FIG. 10 illustrates the potential steps of an example method 1000. The example method 1000 may include: receiving an indication of at least one measurement capability of a user equipment, wherein the at least one measurement capability comprises, at least, an indication that the user equipment is capable of measuring at least one carrier without at least one measurement gap, 1010; determining whether the at least one carrier is to be measured within the at least one measurement gap based, at least partially, on the at least one measurement capability, 1020; transmitting, to the user equipment, an indication of at least one measurement configuration, wherein the at least one measurement configuration comprises, at least, an indication to measure the at least one carrier within the at least one measurement gap in response to a determination that the at least one carrier is to be measured within the measurement gap, 1030; and scheduling the at least one measurement gap, 1040. The example method 1000 may be performed, for example, with a network node, base station, network entity, eNB, gNB, etc.

In accordance with one example embodiment, an apparatus may comprise: at least one processor; and at least one memory storing instructions that, when executed by the at least one processor, cause the apparatus at least to: transmit an indication of at least one measurement capability, wherein the at least one measurement capability may comprise, at least, an indication of at least one carrier that can be measured without at least one measurement gap; receive an indication of at least one measurement configuration, wherein the at least one measurement configuration may comprise, at least, an indication that the apparatus is capable of measuring at least one carrier without at least one measurement gap; and measure the at least one carrier within the at least one measurement gap based, at least partially, on the at least one measurement configuration.

The indication of the at least one measurement capability may comprise at least one of: an indication of whether a first measurement gap is needed for measurement of a first carrier, or an indication of whether a first interruption is needed for the measurement of the first carrier.

The indication to measure the at least one carrier within the measurement gap may comprise at least one of: an indication of at least one first measurement object to be measured within the at least one measurement gap, or an indication of at least one second measurement object to be measured outside the at least one measurement gap.

The indication to measure the at least one carrier within the measurement gap may comprise at least one of: an indication of at least one first frequency band to be measured within the at least one measurement gap, or an indication of at least one second frequency band to be measured outside the at least one measurement gap.

The at least one measurement configuration may further comprise an indication of a measurement gap pattern.

The example apparatus may be further configured to at least one of: perform measurements on at least one first frequency band within the at least one measurement gap in response to the at least one measurement configuration indicating that the at least one first frequency band should be measured within the at least one measurement gap; or perform measurements on at least one second frequency band outside of the at least one measurement gap in response to the at least one measurement configuration indicating that the at least one second frequency band should be measured outside the at least one measurement gap.

The indication of the at least one measurement capability may comprise an indication that the at least one second frequency band can be measured outside the at least one measurement gap.

The at least one measurement configuration may be received via one of: radio resource control signaling, or medium access control signaling.

In accordance with one aspect, an example method may be provided comprising: transmitting, with a user equipment, an indication of at least one measurement capability, wherein the at least one measurement capability may comprise, at least, an indication that the user equipment is capable of measuring at least one carrier without at least one measurement gap; receiving an indication of at least one measurement configuration, wherein the at least one measurement configuration may comprise, at least, an indication to measure the at least one carrier within the at least one measurement gap; and measuring the at least one carrier within the at least one measurement gap based, at least partially, on the at least one measurement configuration.

The indication of the at least one measurement capability may comprise at least one of: an indication of whether a first measurement gap is needed for measurement of a first carrier, or an indication of whether a first interruption is needed for the measurement of the first carrier.

The indication to measure the at least one carrier within the measurement gap may comprise at least one of: an indication of at least one first measurement object to be measured within the at least one measurement gap, or an indication of at least one second measurement object to be measured outside the at least one measurement gap.

The indication to measure the at least one carrier within the measurement gap may comprise at least one of: an indication of at least one first frequency band to be measured within the at least one measurement gap, or an indication of at least one second frequency band to be measured outside the at least one measurement gap.

The at least one measurement configuration may further comprise an indication of a measurement gap pattern.

The example method may further comprise at least one of: performing measurements on at least one first frequency band within the at least one measurement gap in response to the at least one measurement configuration indicating that the at least one first frequency band should be measured within the at least one measurement gap; or performing measurements on at least one second frequency band outside of the at least one measurement gap in response to the at least one measurement configuration indicating that the at least one second frequency band should be measured outside the at least one measurement gap.

The indication of the at least one measurement capability may comprise an indication that the user equipment is capable of measuring the at least one second frequency band outside the at least one measurement gap.

The at least one measurement configuration may be received via one of: radio resource control signaling, or medium access control signaling.

In accordance with one example embodiment, an apparatus may comprise: circuitry configured to perform: transmitting an indication of at least one measurement capability, wherein the at least one measurement capability may comprise, at least, an indication that a user equipment is capable of measuring at least one carrier without at least one measurement gap; circuitry configured to perform: receiving an indication of at least one measurement configuration, wherein the at least one measurement configuration may comprise, at least, an indication to measure the at least one carrier within the at least one measurement gap; and circuitry configured to perform: measuring the at least one carrier within the at least one measurement gap based, at least partially, on the at least one measurement configuration.

In accordance with one example embodiment, an apparatus may comprise: processing circuitry; memory circuitry including computer program code, the memory circuitry and the computer program code configured to, with the processing circuitry, enable the apparatus to: transmit an indication of at least one measurement capability, wherein the at least one measurement capability may comprise, at least, an indication that the apparatus is capable of measuring at least one carrier without at least one measurement gap; receive an indication of at least one measurement configuration, wherein the at least one measurement configuration may comprise, at least, an indication to measure the at least one carrier within the at least one measurement gap; and measure the at least one carrier within the at least one measurement gap based, at least partially, on the at least one measurement configuration.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for: transmitting an indication of at least one measurement capability, wherein the at least one measurement capability may comprise, at least, an indication that the apparatus is capable of measuring at least one carrier without at least one measurement gap; receiving an indication of at least one measurement configuration, wherein the at least one measurement configuration may comprise, at least, an indication to measure the at least one carrier within the at least one measurement gap; and measuring the at least one carrier within the at least one measurement gap based, at least partially, on the at least one measurement configuration.

The indication of the at least one measurement capability may comprise at least one of: an indication of whether a first measurement gap is needed for measurement of a first carrier, or an indication of whether a first interruption is needed for the measurement of the first carrier.

The indication to measure the at least one carrier within the measurement gap may comprise at least one of: an indication of at least one first measurement object to be measured within the at least one measurement gap, or an indication of at least one second measurement object to be measured outside the at least one measurement gap.

The indication to measure the at least one carrier within the measurement gap may comprise at least one of: an indication of at least one first frequency band to be measured within the at least one measurement gap, or an indication of at least one second frequency band to be measured outside the at least one measurement gap.

The at least one measurement configuration may further comprise an indication of a measurement gap pattern.

The means may be further configured for at least one of: performing measurements on at least one first frequency band within the at least one measurement gap in response to the at least one measurement configuration indicating that the at least one first frequency band should be measured within the at least one measurement gap; or performing measurements on at least one second frequency band outside of the at least one measurement gap in response to the at least one measurement configuration indicating that the at least one second frequency band should be measured outside the at least one measurement gap.

The indication of the at least one measurement capability may comprise an indication that the apparatus is capable of measuring the at least one second frequency band outside the at least one measurement gap.

The at least one measurement configuration may be received via one of: radio resource control signaling, or medium access control signaling.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: cause transmitting of an indication of at least one measurement capability, wherein the at least one measurement capability may comprise, at least, an indication that a user equipment is capable of measuring at least one carrier without at least one measurement gap; cause receiving of an indication of at least one measurement configuration, wherein the at least one measurement configuration may comprise, at least, an indication to measure the at least one carrier within the at least one measurement gap; and measure the at least one carrier within the at least one measurement gap based, at least partially, on the at least one measurement configuration.

In accordance with one example embodiment, a non-transitory computer-readable medium comprising program instructions stored thereon for performing at least the following: causing transmitting of an indication of at least one measurement capability, wherein the at least one measurement capability may comprise, at least, an indication that a user equipment is capable of measuring at least one carrier without at least one measurement gap; causing receiving of an indication of at least one measurement configuration, wherein the at least one measurement configuration may comprise, at least, an indication to measure the at least one carrier within the at least one measurement gap; and measuring the at least one carrier within the at least one measurement gap based, at least partially, on the at least one measurement configuration.

In accordance with another example embodiment, a non-transitory program storage device readable by a machine may be provided, tangibly embodying instructions executable by the machine for performing operations, the operations comprising: causing transmitting of an indication of at least one measurement capability, wherein the at least one measurement capability may comprise, at least, an indication that a user equipment is capable of measuring at least one carrier without at least one measurement gap; causing receiving of an indication of at least one measurement configuration, wherein the at least one measurement configuration may comprise, at least, an indication to measure the at least one carrier within the at least one measurement gap; and measuring the at least one carrier within the at least one measurement gap based, at least partially, on the at least one measurement configuration.

In accordance with another example embodiment, a non-transitory computer-readable medium comprising instructions that, when executed by an apparatus, cause the apparatus to perform at least the following: causing transmitting of an indication of at least one measurement capability, wherein the at least one measurement capability may comprise, at least, an indication that a user equipment is capable of measuring at least one carrier without at least one measurement gap; causing receiving of an indication of at least one measurement configuration, wherein the at least one measurement configuration may comprise, at least, an indication to measure the at least one carrier within the at least one measurement gap; and measuring the at least one carrier within the at least one measurement gap based, at least partially, on the at least one measurement configuration.

A computer implemented system comprising: at least one processor and at least one non-transitory memory storing instructions that, when executed by the at least one processor, cause the system at least to perform: causing transmitting of an indication of at least one measurement capability, wherein the at least one measurement capability may comprise, at least, an indication that a user equipment is capable of measuring at least one carrier without at least one measurement gap; causing receiving of an indication of at least one measurement configuration, wherein the at least one measurement configuration may comprise, at least, an indication to measure the at least one carrier within the at least one measurement gap; and measuring the at least one carrier within the at least one measurement gap based, at least partially, on the at least one measurement configuration.

A computer implemented system comprising: means for causing transmitting of an indication of at least one measurement capability, wherein the at least one measurement capability may comprise, at least, an indication that a user equipment is capable of measuring at least one carrier without at least one measurement gap; means for causing receiving of an indication of at least one measurement configuration, wherein the at least one measurement configuration may comprise, at least, an indication to measure the at least one carrier within the at least one measurement gap; and means for measuring the at least one carrier within the at least one measurement gap based, at least partially, on the at least one measurement configuration.

In accordance with one example embodiment, an apparatus may comprise: at least one processor; and at least one memory storing instructions that, when executed by the at least one processor, cause the apparatus at least to: receive an indication of at least one measurement capability of a user equipment, wherein the at least one measurement capability may comprise, at least, an indication that the user equipment is capable of measuring at least one carrier without at least one measurement gap; determine whether the at least one carrier is to be measured within the at least one measurement gap based, at least partially, on the at least one measurement capability; transmit, to the user equipment, an indication of at least one measurement configuration, wherein the at least one measurement configuration comprises, at least, an indication to measure the at least one carrier within the at least one measurement gap in response to a determination that the at least one carrier is to be measured within the measurement gap; and schedule the at least one measurement gap.

The indication of the at least one measurement capability may comprise at least one of: an indication of whether a first measurement gap is needed for measurement of a first carrier, or an indication of whether a first interruption is needed for the measurement of the first carrier.

The indication to measure the at least one carrier within the measurement gap may comprise at least one of: an indication of at least one first measurement object to be measured within the at least one measurement gap, or an indication of at least one second measurement object to be measured outside the at least one measurement gap.

The indication to measure the at least one carrier within the measurement gap may comprise at least one of: an indication of at least one first frequency band to be measured within the at least one measurement gap, or an indication of at least one second frequency band to be measured outside the at least one measurement gap.

The at least one measurement configuration may further comprise an indication of a measurement gap pattern.

The at least one measurement configuration may comprise at least one of: an indication to measure at least one first frequency band within the at least one measurement gap, or an indication to measure at least one second frequency band outside the at least one measurement gap.

The indication of the at least one measurement capability may comprise an indication that the user equipment is capable of measuring the at least one second frequency band outside the at least one measurement gap.

The at least one measurement configuration may be transmitted via one of: radio resource control signaling, or medium access control signaling.

In accordance with one aspect, an example method may be provided comprising: receiving, with a network node, an indication of at least one measurement capability of a user equipment, wherein the at least one measurement capability may comprise, at least, an indication that the user equipment is capable of measuring at least one carrier without at least one measurement gap; determining whether the at least one carrier is to be measured within the at least one measurement gap based, at least partially, on the at least one measurement capability; transmitting, to the user equipment, an indication of at least one measurement configuration, wherein the at least one measurement configuration may comprise, at least, an indication to measure the at least one carrier within the at least one measurement gap in response to a determination that the at least one carrier is to be measured within the measurement gap; and scheduling the at least one measurement gap.

The indication of the at least one measurement capability may comprise at least one of: an indication of whether a first measurement gap is needed for measurement of a first carrier, or an indication of whether a first interruption is needed for the measurement of the first carrier.

The indication to measure the at least one carrier within the measurement gap may comprise at least one of: an indication of at least one first measurement object to be measured within the at least one measurement gap, or an indication of at least one second measurement object to be measured outside the at least one measurement gap.

The indication to measure the at least one carrier within the measurement gap may comprise at least one of: an indication of at least one first frequency band to be measured within the at least one measurement gap, or an indication of at least one second frequency band to be measured outside the at least one measurement gap.

The at least one measurement configuration may further comprise an indication of a measurement gap pattern.

The at least one measurement configuration may comprise at least one of: an indication to measure at least one first frequency band within the at least one measurement gap, or an indication to measure at least one second frequency band outside the at least one measurement gap.

The indication of the at least one measurement capability may comprise an indication that the user equipment is capable of measuring the at least one second frequency band outside the at least one measurement gap.

The at least one measurement configuration may be transmitted via one of: radio resource control signaling, or medium access control signaling.

In accordance with one example embodiment, an apparatus may comprise: circuitry configured to perform: receiving an indication of at least one measurement capability of a user equipment, wherein the at least one measurement capability may comprise, at least, an indication that the user equipment is capable of measuring at least one carrier without at least one measurement gap; circuitry configured to perform: determining whether the at least one carrier is to be measured within the at least one measurement gap based, at least partially, on the at least one measurement capability; circuitry configured to perform: transmitting, to the user equipment, an indication of at least one measurement configuration, wherein the at least one measurement configuration may comprise, at least, an indication to measure the at least one carrier within the at least one measurement gap in response to a determination that the at least one carrier is to be measured within the measurement gap; and circuitry configured to perform: scheduling the at least one measurement gap.

In accordance with one example embodiment, an apparatus may comprise: processing circuitry; memory circuitry including computer program code, the memory circuitry and the computer program code configured to, with the processing circuitry, enable the apparatus to: receive an indication of at least one measurement capability of a user equipment, wherein the at least one measurement capability may comprise, at least, an indication that the user equipment is capable of measuring at least one carrier without at least one measurement gap; determine whether the at least one carrier is to be measured within the at least one measurement gap based, at least partially, on the at least one measurement capability; transmit, to the user equipment, an indication of at least one measurement configuration, wherein the at least one measurement configuration comprises, at least, an indication to measure the at least one carrier within the at least one measurement gap in response to a determination that the at least one carrier is to be measured within the measurement gap; and schedule the at least one measurement gap.

In accordance with one example embodiment, an apparatus may comprise means for: receiving an indication of at least one measurement capability of a user equipment, wherein the at least one measurement capability may comprise, at least, an indication that the user equipment is capable of measuring at least one carrier without at least one measurement gap; determining whether the at least one carrier is to be measured within the at least one measurement gap based, at least partially, on the at least one measurement capability; transmitting, to the user equipment, an indication of at least one measurement configuration, wherein the at least one measurement configuration may comprise, at least, an indication to measure the at least one carrier within the at least one measurement gap in response to a determination that the at least one carrier is to be measured within the measurement gap; and scheduling the at least one measurement gap.

The indication of the at least one measurement capability may comprise at least one of: an indication of whether a first measurement gap is needed for measurement of a first carrier, or an indication of whether a first interruption is needed for the measurement of the first carrier.

The indication to measure the at least one carrier within the measurement gap may comprise at least one of: an indication of at least one first measurement object to be measured within the at least one measurement gap, or an indication of at least one second measurement object to be measured outside the at least one measurement gap.

The indication to measure the at least one carrier within the measurement gap may comprise at least one of: an indication of at least one first frequency band to be measured within the at least one measurement gap, or an indication of at least one second frequency band to be measured outside the at least one measurement gap.

The at least one measurement configuration may further comprise an indication of a measurement gap pattern.

The at least one measurement configuration may comprise at least one of: an indication to measure at least one first frequency band within the at least one measurement gap, or an indication to measure at least one second frequency band outside the at least one measurement gap.

The indication of the at least one measurement capability may comprise an indication that the user equipment is capable of measuring the at least one second frequency band outside the at least one measurement gap.

The at least one measurement configuration may be transmitted via one of: radio resource control signaling, or medium access control signaling.

In accordance with one example embodiment, a non-transitory computer-readable medium comprising instructions stored thereon which, when executed with at least one processor, cause the at least one processor to: cause receiving of an indication of at least one measurement capability of a user equipment, wherein the at least one measurement capability may comprise, at least, an indication that the user equipment is capable of measuring at least one carrier without at least one measurement gap; determine whether the at least one carrier is to be measured within the at least one measurement gap based, at least partially, on the at least one measurement capability; cause transmitting, to the user equipment, of an indication of at least one measurement configuration, wherein the at least one measurement configuration may comprise, at least, an indication to measure the at least one carrier within the at least one measurement gap in response to a determination that the at least one carrier is to be measured within the measurement gap; and schedule the at least one measurement gap.

In accordance with one example embodiment, a non-transitory computer-readable medium comprising program instructions stored thereon for performing at least the following: causing receiving of an indication of at least one measurement capability of a user equipment, wherein the at least one measurement capability may comprise, at least, an indication that the user equipment is capable of measuring at least one carrier without at least one measurement gap; determining whether the at least one carrier is to be measured within the at least one measurement gap based, at least partially, on the at least one measurement capability; causing transmitting, to the user equipment, of an indication of at least one measurement configuration, wherein the at least one measurement configuration may comprise, at least, an indication to measure the at least one carrier within the at least one measurement gap in response to a determination that the at least one carrier is to be measured within the measurement gap; and scheduling the at least one measurement gap.

In accordance with another example embodiment, a non-transitory program storage device readable by a machine may be provided, tangibly embodying instructions executable by the machine for performing operations, the operations comprising: causing receiving of an indication of at least one measurement capability of a user equipment, wherein the at least one measurement capability may comprise, at least, an indication that the user equipment is capable of measuring at least one carrier without at least one measurement gap; determining whether the at least one carrier is to be measured within the at least one measurement gap based, at least partially, on the at least one measurement capability; causing transmitting, to the user equipment, of an indication of at least one measurement configuration, wherein the at least one measurement configuration may comprise, at least, an indication to measure the at least one carrier within the at least one measurement gap in response to a determination that the at least one carrier is to be measured within the measurement gap; and scheduling the at least one measurement gap.

In accordance with another example embodiment, a non-transitory computer-readable medium comprising instructions that, when executed by an apparatus, cause the apparatus to perform at least the following: causing receiving of an indication of at least one measurement capability of a user equipment, wherein the at least one measurement capability may comprise, at least, an indication that the user equipment is capable of measuring at least one carrier without at least one measurement gap; determining whether the at least one carrier is to be measured within the at least one measurement gap based, at least partially, on the at least one measurement capability; causing transmitting, to the user equipment, of an indication of at least one measurement configuration, wherein the at least one measurement configuration may comprise, at least, an indication to measure the at least one carrier within the at least one measurement gap in response to a determination that the at least one carrier is to be measured within the measurement gap; and scheduling the at least one measurement gap.

A computer implemented system comprising: at least one processor and at least one non-transitory memory storing instructions that, when executed by the at least one processor, cause the system at least to perform: causing receiving of an indication of at least one measurement capability of a user equipment, wherein the at least one measurement capability may comprise, at least, an indication that the user equipment is capable of measuring at least one carrier without at least one measurement gap; determining whether the at least one carrier is to be measured within the at least one measurement gap based, at least partially, on the at least one measurement capability; causing transmitting, to the user equipment, of an indication of at least one measurement configuration, wherein the at least one measurement configuration may comprise, at least, an indication to measure the at least one carrier within the at least one measurement gap in response to a determination that the at least one carrier is to be measured within the measurement gap; and scheduling the at least one measurement gap.

A computer implemented system comprising: means for causing receiving of an indication of at least one measurement capability of a user equipment, wherein the at least one measurement capability may comprise, at least, an indication that the user equipment is capable of measuring at least one carrier without at least one measurement gap; means for determining whether the at least one carrier is to be measured within the at least one measurement gap based, at least partially, on the at least one measurement capability; means for causing transmitting, to the user equipment, of an indication of at least one measurement configuration, wherein the at least one measurement configuration may comprise, at least, an indication to measure the at least one carrier within the at least one measurement gap in response to a determination that the at least one carrier is to be measured within the measurement gap; and means for scheduling the at least one measurement gap.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1.-44. (canceled)

45. An apparatus comprising:
at least one processor; and
at least one non-transitory memory storing instructions that, when executed by the at least one processor, cause the apparatus at least to:
transmit an indication of at least one measurement capability, wherein the indication of the at least one measurement capability comprises an indication that the apparatus is capable of measuring at least one carrier without at least one measurement gap, an indication of whether a first measurement gap is needed for measurement of a first carrier, and an indication of whether a first interruption is needed for the measurement of the first carrier;
receive an indication of at least one measurement configuration, wherein the indication of the at least one measurement configuration comprises an indication to measure at least one carrier within the at least one measurement gap, wherein the indication to measure the at least one carrier within the measurement gap comprises: an indication of at least one first measurement object to be measured within the at least one measurement gap, an indication of at least one second measurement object to be measured outside the at least one measurement gap, an indication of at least one first frequency band to be measured within the at least one measurement gap, and an indication of at least one second frequency band to be measured outside the at least one measurement gap;
measure the at least one carrier within the at least one measurement gap based, at least partially, on the at least one measurement configuration;
perform measurements on at least one first frequency band within the at least one measurement gap in response to the at least one measurement configuration indicating that the at least one first frequency band should be measured within the at least one measurement gap; and
perform measurements on at least one second frequency band outside of the at least one measurement gap in response to the at least one measurement configuration indicating that the at least one second frequency band should be measured outside the at least one measurement gap.

46. The apparatus of claim 45, wherein the at least one measurement configuration further comprises an indication of a measurement gap pattern.

47. The apparatus of claim 46, wherein the at least one measurement configuration is received via radio resource control signaling.

48. The apparatus of claim 47, wherein the at least one measurement configuration is received via medium access control signaling.

49. The apparatus of claim 48, wherein the at least one non-transitory memory stores further instructions that, when executed by the at least one processor, cause the apparatus to:
perform measurements on the at least one carrier without interruptions.

50. The apparatus of claim 49, wherein the at least one memory stores further instructions that, when executed by the at least one processor, cause the apparatus to:
perform the measurement on the at least one carrier without measurement gaps.

51. The apparatus of claim 50, wherein the at least one memory stores further instructions that, when executed by the at least one processor, cause the apparatus to:
receive instructions that explicitly indicate which carriers are to be measured within measurement gaps.

52. A system comprising:
an apparatus:
at least one processor; and
at least one non-transitory memory storing instructions that, when executed by the at least one processor, cause the apparatus at least to:
transmit an indication of at least one measurement capability, wherein the indication of the at least one measurement capability comprises an indication that the apparatus is capable of measuring at least one carrier without at least one measurement gap, an indication of whether a first measurement gap is needed for measurement of a first carrier, and an indication of whether a first interruption is needed for the measurement of the first carrier;
receive an indication of at least one measurement configuration, wherein the indication of the at least one measurement configuration comprises an indication to measure at least one carrier within the at least one measurement gap, wherein the indication to measure the at least one carrier within the measurement gap comprises: an indication of at least one first measurement object to be measured within the at least one measurement gap, an indication of at least one second measurement object to be measured outside the at least one measurement gap, an indication of at least one first frequency band to be measured within the at least one measurement gap, and an indication of at least one second frequency band to be measured outside the at least one measurement gap;
measure the at least one carrier within the at least one measurement gap based, at least partially, on the at least one measurement configuration;
perform measurements on at least one first frequency band within the at least one measurement gap in response to the at least one measurement configuration indicating that the at least one first frequency band should be measured within the at least one measurement gap; and
perform measurements on at least one second frequency band outside of the at least one measurement gap in response to the at least one measurement configuration indicating that the at least one second frequency band should be measured outside the at least one measurement gap.

53. The system of claim 52, wherein the at least one measurement configuration further comprises an indication of a measurement gap pattern.

54. The system of claim 53, wherein the at least one measurement configuration is received via radio resource control signaling.

55. The system of claim 54, wherein the at least one measurement configuration is received via medium access control signaling.

56. The system of claim 55, wherein the at least one non-transitory memory stores further instructions that, when executed by the at least one processor, cause the apparatus to:
perform measurements on the at least one carrier without interruptions.

57. The system of claim 56, wherein the at least one memory stores further instructions that, when executed by the at least one processor, cause the apparatus to:
perform the measurement on the at least one carrier without measurement gaps.

58. The system of claim 57, wherein the at least one memory stores further instructions that, when executed by the at least one processor, cause the apparatus to:
receive instructions that explicitly indicate which carriers are to be measured within measurement gaps.

59. A method comprising:
transmitting, by an apparatus, an indication of at least one measurement capability, wherein the indication of the at least one measurement capability comprises an indication that the apparatus is capable of measuring at least one carrier without at least one measurement gap, an indication of whether a first measurement gap is needed for measurement of a first carrier, and an indication of whether a first interruption is needed for the measurement of the first carrier;
receiving, by the apparatus, an indication of at least one measurement configuration, wherein the indication of the at least one measurement configuration comprises an indication to measure at least one carrier within the at least one measurement gap, wherein the indication to measure the at least one carrier within the measurement gap comprises: an indication of at least one first measurement object to be measured within the at least one measurement gap, an indication of at least one second measurement object to be measured outside the at least one measurement gap, an indication of at least one first frequency band to be measured within the at least one measurement gap, and an indication of at least one second frequency band to be measured outside the at least one measurement gap;
measuring, by the apparatus, the at least one carrier within the at least one measurement gap based, at least partially, on the at least one measurement configuration;
performing, by the apparatus, measurements on at least one first frequency band within the at least one measurement gap in response to the at least one measurement configuration indicating that the at least one first frequency band should be measured within the at least one measurement gap; and
performing, by the apparatus, measurements on at least one second frequency band outside of the at least one measurement gap in response to the at least one measurement configuration indicating that the at least one second frequency band should be measured outside the at least one measurement gap.

60. The method of claim 59, wherein the at least one measurement configuration further comprises an indication of a measurement gap pattern.

61. The method of claim 60, wherein the at least one measurement configuration is received via radio resource control signaling.

62. The method of claim 61, wherein the at least one measurement configuration is received via medium access control signaling.

63. The method of claim 62, further comprising:
performing measurements on the at least one carrier without interruptions; and
perform the measurement on the at least one carrier without measurement gaps.

64. The method of claim 63, further comprising:
receiving instructions that explicitly indicate which carriers are to be measured within measurement gaps.
